(19) United States
(12) Patent Application Publication
(10) Pub. No.: US 2025/0030556 A1
(43) Pub. Date: Jan. 23, 2025

(54) TERMINAL PROFILE GENERATION

(71) Applicant: Apple Inc., Cupertino, CA (US)

(72) Inventors: Marawan Ragab, Laval (CA); Alexandre Perematko, San Jose, CA (US); Catalin Giurca, Santa Clara, CA (US); Raphael Hudon-Voyer, Montreal (CA); Vitaliy Belitsky, Montreal (CA)

(73) Assignee: Apple Inc., Cupertino, CA (US)

(21) Appl. No.: 18/353,802

(22) Filed: Jul. 17, 2023

(51) Int. Cl. H04L 9/32; G06F 21/60

(52) U.S. Cl. CPC H04L 9/3247; G06F 21/602

(57) ABSTRACT

The present application relates to devices and components including apparatus, systems, and methods to generate profiles, in an automated manner, for kernels to be utilized for data transfers.

### BACKGROUND

Computer terminals have developed to support data transfers between accounts. In particular, the computer terminals can facilitate data transfers between accounts associated with the terminals. The terminals can interact with a service provider that manages one or more of the accounts between which the data transfers are to occur. The service provider can define limits for the data transfers through use of profiles. In particular, profiles can be associated with kernels operating on the terminals that facilitate the data transfers between the accounts, where the profiles define limits for the data transfers. In legacy approaches, generating these profiles is a manual intensive procedure, requiring input of individuals to produce the profiles.

### BRIEF DESCRIPTION OF THE DRAWINGS

FIG. 1 illustrates an example system arrangement in accordance with some embodiments.

FIG. 2 illustrates an example procedure in accordance with some embodiments.

FIG. 3 illustrates a first portion of a flow chart for an example procedure in accordance with some embodiments.

FIG. 4 illustrates a second portion of the flow chart for the example procedure of FIG. 3 in accordance with some embodiments.

FIG. 5 illustrates a third portion of the flow chart for the example procedure of FIG. 3 in accordance with some embodiment.

FIG. 6 illustrates an example procedure for generating a profile in accordance with some embodiments.

FIG. 7 illustrates an example user equipment (UE) in accordance with some embodiments.

FIG. 8 is a block diagram of an example computing device that can implement the features and processes of FIGS. 1-6 in accordance with some embodiments.

FIG. 9 illustrates an example architecture or environment configured to implement techniques described herein in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Embodiments described herein may relate to procedures for generating profiles for kernels to be utilized for data transfers. In particular, the generation of the profiles can be automated, thereby allowing for little to no human interaction to generate the profiles. The automated procedures for generating the profiles can be performed faster than the legacy approaches that involved human interaction. Further, the profiles may require certification in some instances, where the automated procedures for generating the profiles may provide for quicker updates that could lead to certifications being obtained faster than the legacy approaches.

Embodiments described herein may include a system that can generate profiles to be utilized for data transfers. In particular, the system can generate profiles that can be assigned to kernels that are utilized to perform the data transfers. The system can receive a request to generate a profile that includes a definition of characteristics for a profile to be generated by the system. In embodiments, the definition of characteristics may be received as a data file that provides the defined characteristics for the profile. The system may perform validation operations on the data file and/or the definition of characteristics to verify that the request for the profile is valid and/or authorized to be performed.

The system can utilize the data file and/or the definition of characteristics to generate a binary file that indicates the characteristics. To indicate validity of the binary file, the system may cause the binary file to be signed. The system may generate one or more keys and/or a certificate chain with which to sign the binary file. The system may sign the binary file with the keys and/or the certificate chain to produce the profile, the profile being the signed binary file. The system can make the profile available for testing and/or available for download to terminals to be utilized for data transfers. In some embodiments, the data transfers may comprise financial transactions, where the terminals may cause value to be exchanged between the accounts associated with the terminals.

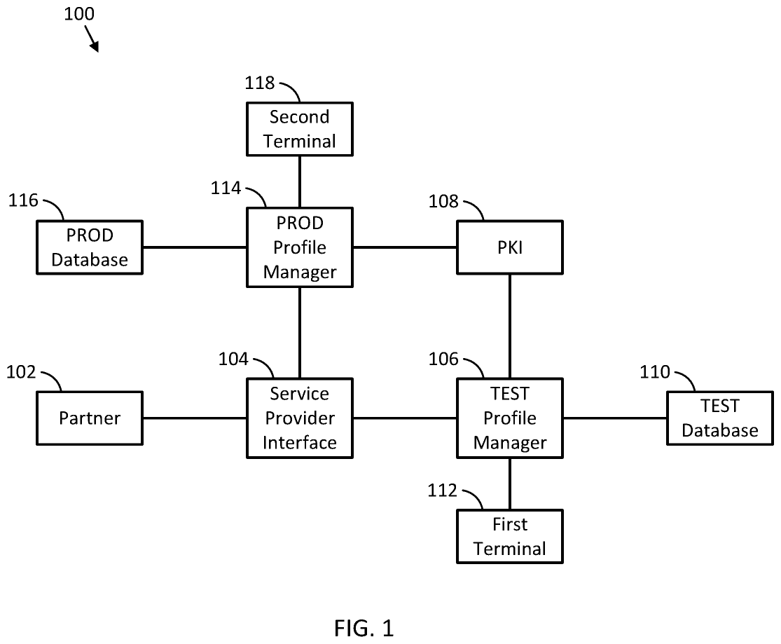

FIG. 1 illustrates an example system arrangement 100 in accordance with some embodiments. The system arrangement 100 may implement approaches for generating profiles for kernels to be utilized for data transfers in an automated matter. For example, the profiles may be assigned to kernels that can be utilized in a point of sale (POS) device and/or a device acting as POS for conducting payment transactions involving at least two accounts in some embodiments. The system arrangement 100 may be capable of generating profiles for testing and/or production implementation. The system arrangement 100, or portions thereof, may provide the profiles to terminals for implementation.

The system arrangement 100 may include a partner device 102. The partner device 102 may be a computer device associated with a service provider. The service provider may utilize the partner device 102 to access other elements within the system arrangement 100 to request profiles to be generated for the service provider. In some instances, the partner device 102 may store and/or be utilized to generate data files utilized for generating profiles. In some embodiments, the data files may be YAML files.

The system arrangement 100 may include a service provider interface device 104. The service provider interface device 104 may host a portal that can be accessed by partner devices, such as the partner device 102. The portal hosted by the service provider interface device 104 may provide an interface that allows a partner device 102 to upload a data file for generating a profile, define characteristics utilized for producing a data file, and/or duplicate and amend a data file from a previously generated profile. The partner device 102 may establish a connection with the service provider interface device 104.

The service provider interface device 104 may convert the data file into other files for generating the profile and/or validating the data file. For example, the service provider interface device 104 may convert the data file into an intermediate file. The intermediate file may be utilized for validation of the data file in some embodiments.

The service provider interface device 104 may validate the data files received (through any of the upload of the data file, the produced data file, and/or the duplicated and amended data file). For example, the service provider interface device 104 may validate the data files to verify that the profiles corresponding to the data files are authorized to be generated, and/or that the data files have correct formats and/or acceptable characteristics. In some embodiments, the service provider interface device 104 may verify that the formats of entries within the data files are correct. Further, the service provider interface device 104 may verify that values within the data files are acceptable and/or that interdependency between the values within the data files are acceptable.

The system arrangement 100 may include a TEST profile manager 106. The TEST profile manager 106 may be coupled to the service provider interface device 104 and may receive intermediate files from the service provider interface device 104. The TEST profile manager 106 may convert the intermediate file into a binary file to be utilized for the profile. The binary file may define the characteristics for the profile and/or may include information from the data file. In some embodiments, the characteristics may include a maximum value to be transferred between accounts by a kernel associated with the profile, kernels to which the profile can be assigned, payment cards for which the profile can be utilized, or other limitations on use related to the profile.

The TEST profile manager 106 may generate one or more keys utilized for signing the binary files to produce profiles. In some embodiments, the one or more keys generated by the TEST profile manager 106 may include a public key and a private key to be utilized for signing the binary files. In some embodiments, the one or more keys generated by the TEST profile manager 106 may be particular to the TEST profile manager 106.

The TEST profile manager 106 may generate a certificate signing request (CSR) to request a certificate chain for the profile. The CSR may include one or more keys generated by the TEST profile manager 106. For example, the TEST profile manager 106 may generate the CSR based one or more keys generated by the TEST profile manager 106. The CSR may include a public key generated by the TEST profile manager 106.

The system arrangement 100 may include a public key infrastructure (PKI) 108. The PKI 108 may generate certificate chains for profiles. The PKI 108 may be coupled to the TEST profile manager 106 and may receive the CSRs from the TEST profile manager 106. The PKI 108 may generate a certificate chain for generating a profile with the data file. The PKI 108 may utilize the CSR with one or more keys available to the PKI 108 to generate the certificate chain. The certificate chain generated by the PKI 108 based on the CSR received from the TEST profile manager 106 may include one or more certificates corresponding to the PKI 108 and/or one or more certificates corresponding to the TEST profile manager 106. The PKI 108 may provide the generated certificate chain to the TEST profile manager 106.

The TEST profile manager 106 may receive the certificate chain from the PKI 108. The TEST profile manager 106 may utilize the received certificate chain and the binary file to generate a profile. For example, the TEST profile manager 106 may utilize the certificate chain to sign the profile. The system arrangement 100 may include a TEST database 110 for storing profiles related to the TEST profile manager 106. The TEST profile manager 106 may store the generated profile in the TEST database 110. The TEST profile manager 106 may store the profile associated with a profile identifier (ID). The profile ID may be utilized for identifying the profile. The TEST profile manager 106 may assign the profile ID to the profile. In some embodiments, the TEST profile manager 106 may store the data file and/or the binary file corresponding to the profile with the profile.

Once the profile has been generated, the TEST profile manager 106 may provide profile ID to the service provider interface device 104 and indicate that the profile ID is associated with the generated profile. The service provider interface device 104 may forward the profile ID to the partner device 102. The profile ID may be presented to a user of the partner device 102 and the user of the partner device 102 may utilize the profile ID to reference the generated profile.

Terminals, such as a first terminal 112, may establish a connection with the TEST profile manager 106 to retrieve profiles from the TEST profile manager 106. For example, the first terminal 112 may provide a request to the TEST profile manager 106 for a profile. The request may include a profile ID corresponding to the requested profile. The TEST profile manager 106 may verify that the first terminal 112 is authorized to retrieve the requested profile. The TEST profile manager 106 may provide limited access to certain terminals. For example, the TEST profile manager 106 may limit access to terminals authorized for testing the profiles, which may comprise terminals authorized by the service provider. If the TEST profile manager 106 determines that the first terminal 112 is authorized to access the requested profile, the TEST profile manager 106 may determine whether the profile is stored within the TEST database 110 and retrieve the profile from the TEST database 110 if it determined that the profile is stored within the TEST database 110. The TEST profile manager 106 may provide the retrieved profile to the first terminal 112 based on the request received from the first terminal 112.

The service provider interface device 104 may further receive a request to promote a profile to production (PROD) from the partner device 102. In particular, the partner device 102 may transmit a request to promote a previously generated TEST profile to a PROD profile. The request to promote the profile may include a profile ID corresponding to the profile to be promoted. The service provider interface device 104 may identify the profile to be promoted using the profile ID. The service provider interface device 104 may retrieve a data file and/or an intermediate file corresponding to the profile to be promoted based on the request.

The system arrangement 100 may include a PROD profile manager 114. The service provider interface device 104 may provide the intermediate file corresponding to the profile to be promoted to the PROD profile manager 114. In particular, the PROD profile manager 114 may be coupled to the service provider interface device 104 and may receive the intermediate file from the service provider interface device 104. The PROD profile manager 114 may convert the intermediate file into a binary file to be utilized for the profile.

The PROD profile manager 114 may generate one or more keys utilized for signing the binary files to produce profiles. The one or more keys generated by the PROD profile manager 114 may be different than the one or more keys generated by the TEST profile manager 106. In some embodiments, the one or more keys generated by the PROD profile manager 114 may include a public key and a private key to be utilized for signing the binary file. In some embodiments, the one or more keys generated by the PROD profile manager 114 may be particular to the PROD profile manager 114.

The PROD profile manager 114 may generate a CSR to request a certificate chain for the profile. The CSR may include the public key generated by the PROD profile manager 114. The PROD profile manager 114 may generate the CSR based on the public key generated by the PROD profile manager 114.

The PROD profile manager 114 may provide the CSR to the PK 108. In particular, the PKI 108 may be coupled to the PROD profile manager 114 and may receive the CSR from the PROD profile manager 114. The PKI 108 may generate a certificate chain for generating a profile with the data file. The certificate chain generated by the PKI 108 based on the CSR received from the PROD profile manager 114 may include one or more certificates corresponding to the PKI 108 and/or one or more certificates corresponding to the PROD profile manager 114. The certificate chain generated for the PROD profile manager 114 may be different than the certificate chain generated for the TEST profile manager 106 for the same binary file. The PKI 108 may provide the generated certificate chain to the PROD profile manager 114.

The PROD profile manager 114 may receive the certificate chain from the PKI 108. The PROD profile manager 114 may utilize the received certificate chain and the binary file to generate a profile. For example, the PROD profile manager 114 may utilize the certificate chain to sign the profile. The system arrangement 100 may include a PROD database 116 for storing profiles related to the PROD profile manager 114. The PROD profile manager 114 may store the generated profile in the PROD database 116. The PROD profile manager 114 may store the profile associated with a profile ID. The profile ID may be utilized for identifying the profile. In some embodiments, the profile ID may be the same profile ID as utilized by the TEST profile manager 106 for the profile. In other embodiments, the profile ID may be different from the profile ID as utilized by the TEST profile manager 106, and the PROD profile manager 114 may assign the profile ID to the profile. In some embodiments, the PROD profile manager 114 may store the data file and/or the binary file corresponding to the profile with the profile.

Once the profile has been generated, the PROD profile manager 114 may provide profile ID to the service provider interface device 104 and indicate that the profile ID is associated with the generated profile. The service provider interface device 104 may forward the profile ID to the partner device 102. The profile ID may be presented to a user of the partner device 102 and the user of the partner device 102 may utilize the profile ID to reference the generated profile.

Terminals, such as a second terminal 118 may establish a connection with the PROD profile manager 114 to retrieve profiles from the PROD profile manager 114. For example, the second terminal 118 may provide a request to the PROD profile manager 114 for a profile. The request may include a profile ID corresponding to the requested profile. The PROD profile manager 114 may verify that the second terminal 118 is authorized to retrieve the requested profile. The PROD profile manager 114 may provide expanded access to more terminals than provided to the TEST profile manager 106. For example, the PROD profile manager 114 may provide access to customer terminals authorized by the service provider, which can be more terminals than authorized for accessing terminals from the TEST profile manager 106. If the PROD profile manager 114 determines that the second terminal 118 is authorized to access the requested profile, the PROD profile manager 114 may determine whether the profile is stored within the PROD database 116 and retrieve the profile from the PROD database 116 if it determined that the profile is stored within the PROD database 116. The PROD profile manager 114 may provide the retrieved profile to the second terminal 118 based on the request received from the second terminal 118.

In other embodiments, the system arrangement 100 may include a single profile manager and a single database rather than two profile managers and two databases. In these embodiments, the single profile manager may perform the features of the TEST profile manager 106, the PROD profile manager 114, or both. Further, the single database may perform the features of the TEST database 110, the PROD database 116, or both.

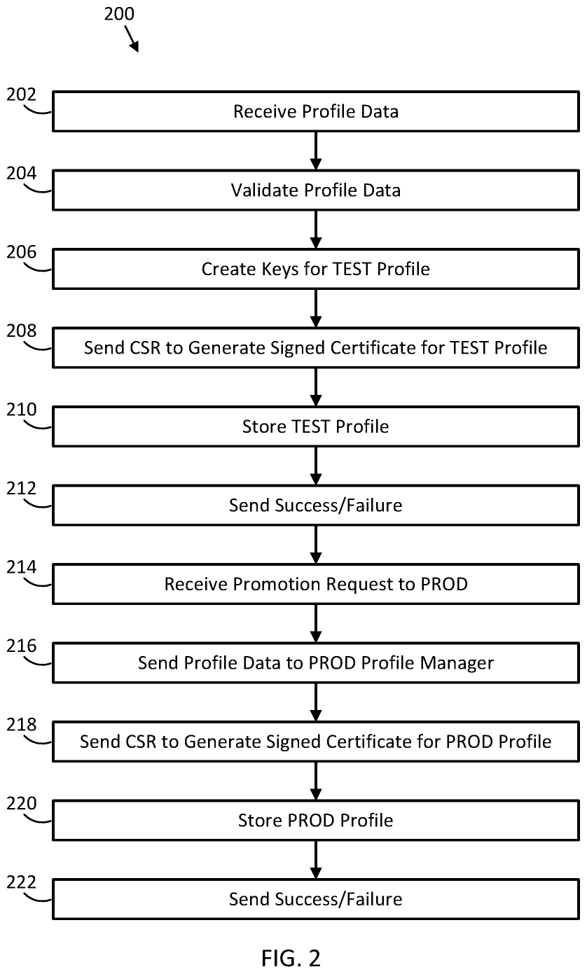

FIG. 2 illustrates an example procedure 200 in accordance with some embodiments. For example, the procedure 200 may be performed by a system, such as the system represented by the system arrangement 100 (FIG. 1). The procedure 200 may be performed to generate a profile for a kernel to be utilized for data transfers.

In 202, the procedure 200 may include receiving profile data. For example, a partner device (such as the partner device 102 (FIG. 1)) may provide profile data to a service provider interface device (such as the service provider interface device 104 (FIG. 1)). Providing the profile data may include providing a data file that includes the profile data, providing characteristics for producing a data file, and/or indicating a previously generated profile to be utilized for generating a data file. The data file may be a YAML data file in some embodiments.

In 204, the procedure 200 may include validating the profile data. For example, the service provider interface device may validate that the profile data have entries in correct formats, values that are acceptable, and/or interdependencies between the values that are acceptable. In some embodiments, the service provider interface device may perform validation procedures on the data file corresponding to the profile data and/or generate an intermediate file corresponding to the data file to perform validation procedures.

In 206, the procedure 200 may include creating keys for a TEST profile. For example, the service provider interface device may generate an intermediate file from the data file. The service provider interface device may provide the intermediate file to a TEST profile manager (such as the TEST profile manager 106 (FIG. 1)). The TEST profile manager may utilize the intermediate file to generate a binary file corresponding to the data file. The TEST profile manager may generate one or more keys to be utilized for producing a requested TEST profile. The one or more keys may correspond to the TEST profile manager in some embodiments.

In 208, the procedure 200 may include sending a CSR to generate a signed certificate for the TEST profile. For example, the TEST profile manager may generate a CSR. The CSR may include one or more keys generated by the TEST profile manager. In some embodiments, the CSR may include a public key generated by the TEST profile manager for the TEST profile. The TEST profile manager may send the CSR to an PKI (such as the PKI 108 (FIG. 1)). The PKI may generate a certificate chain for generating the profile. The PKI may utilize the CSR and/or one or more keys available to the PKI to generate the certificate chain. The PKI may provide the certificate chain to the TEST profile manager.

In 210, the procedure 200 may include storing the TEST profile. For example, the TEST profile manager may generate the TEST profile utilizing the certificate chain received from the PKI and the binary file. In some embodiments, the TEST profile manager may utilize the certificate chain to sign the TEST profile. The TEST profile manager may store the TEST profile in a TEST database (such as the TEST database 110 (FIG. 1)).

In 212, the procedure 200 may include sending a success/failure indication. For example, the TEST profile manager may send a success/failure indication to the service provider interface device based on whether the TEST profile was successfully generated and stored. The success/failure indication may indicate that the TEST profile was successfully generated based on the TEST profile being generated and stored in the TEST database. The success/failure indication may indicate that generation of the TEST profile failed based on the TEST profile failing to be generated and/or stored in the TEST database.

In 214, the procedure 200 may include receiving a promotion request to PROD. For example, the service provider interface device may receive a promotion request to promote the profile from TEST to PROD. The promotion request may include a profile ID that indicates the profile to be promoted. The service provider interface device may determine the profile to be promoted based on the promotion request.

In 216, the procedure 200 may include sending profile data to PROD profile manager. For example, the service provider interface device may send profile data corresponding to the TEST profile to be promoted to a PROD profile manager (such as the PROD profile manager 114 (FIG. 1)). Sending the profile data may include sending the data file that includes the profile data to the PROD profile manager and/or sending the intermediate file corresponding to the profile data to the PROD profile manager. The data file may be a YAML data file in some embodiments. The PROD profile manager may utilize the intermediate file to generate a binary file corresponding to the data file.

In 218, the procedure 200 may include sending a CSR to generate a signed certificate for a PROD profile. For example, the PROD profile manager may generate one or more keys to be utilized for producing a PROD profile. The one or more keys may correspond to the PROD profile manager in some embodiments. The one or more keys produced by the PROD profile manager may be different from the one or more keys produced by the TEST profile manager.

The PROD profile manager may generate a CSR for generating the PROD profile. The CSR may include one or more keys generated by the PROD profile manager. In some embodiments, the CSR may include a public key generated by the PROD profile manager for the PROD profile. The PROD profile manager may send the CSR to the PKI. The PKI may generate a certificate chain for generating the profile. The certificate chain generated for the PROD profile manager may be different from the certificate chain generated for the TEST profile manager. The PKI may provide the certificate chain to the PROD profile manager.

In 220, the procedure 200 may include storing the PROD profile. For example, the PROD profile manager may generate the PROD profile utilizing the certificate chain received from the PKI and the binary file. In some embodiments, the PROD profile manager may utilize the certificate chain to sign the PROD profile. The PROD profile manager may store the PROD profile in a PROD database (such as the PROD database 116 (FIG. 1)).

In 222, the procedure 200 may include sending a success/failure indication. For example, the PROD profile manager may send a success/failure indication to the service provider interface device based on whether the PROD profile was successfully generated and stored. The success/failure indication may indicate that the PROD profile was successfully generated based on the PROD profile being generated and stored in the PROD database. The success/failure indication may indicate that generation of the PROD profile failed based on the PROD profile failing to be generated and/or stored in the PROD database.

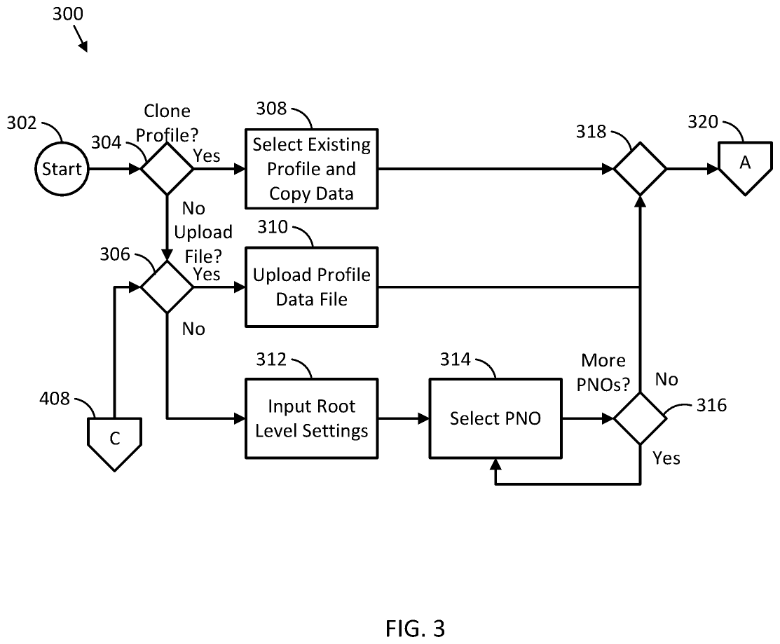

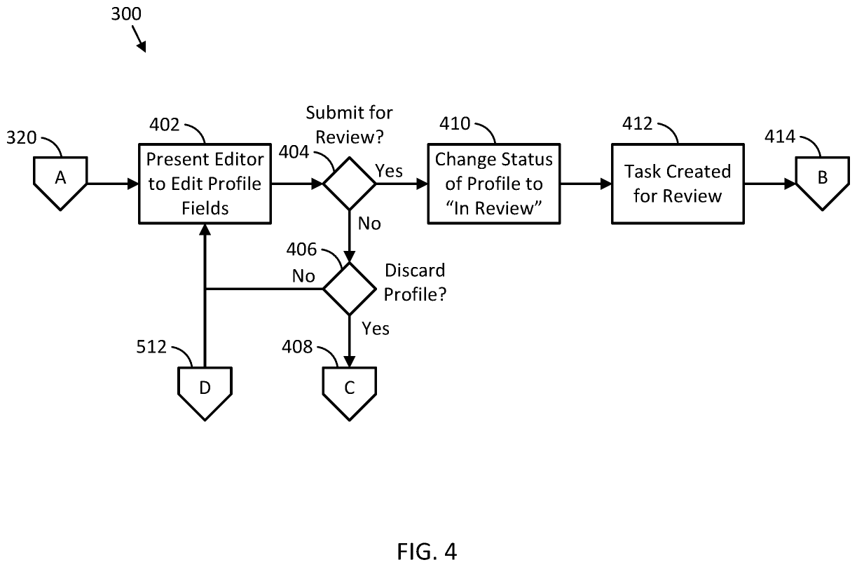

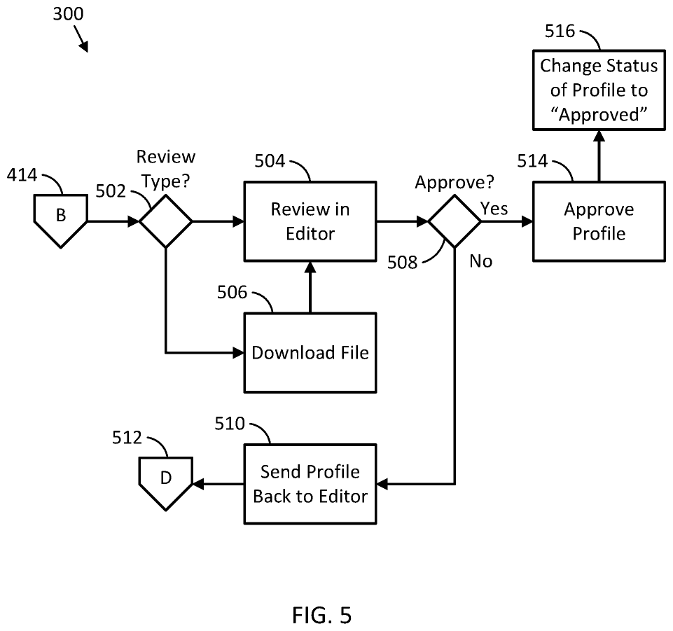

FIG. 3 through FIG. 5 illustrate a flow chart for an example procedure 300 in accordance with some embodiments. For example, FIG. 3 illustrates a first portion of a flow chart for an example procedure 300 in accordance with some embodiments. FIG. 4 illustrates a second portion of the flow chart for the example procedure 300 in accordance with some embodiments. FIG. 5 illustrates a third portion of the flow chart for the example procedure 300 in accordance with some embodiment. The procedure 300 may be performed by a system, such as the system represented by the system arrangement 100 (FIG. 1). The procedure 300 may be performed to generate a profile for a kernel to be utilized for data transfer.

The procedure 300 may start at 302. At 302, a service provider may access a portal for requesting generation of the profile. The portal may be an application with limited access, such as requiring a user to login for use. The service provider may access the portal via a partner device (such as the partner device 102 (FIG. 1)). The portal may be hosted by a service provider interface device (such as the service provider interface device 104 (FIG. 1)). The portal may provide the service provider with one or more operations for defining a configuration for the profile. The configuration for the profile may define characteristics for the profile to be generated. The characteristics may include a maximum value to be transferred between accounts by a kernel associated with the profile, kernels to which the profile can be assigned, payment cards for which the profile can be utilized, or other limitations on use related to the profile.

In some embodiments, the operations for defining the configuration for the profile presented by the portal may include cloning and amending a previously generated profile to define the configuration, upload a data file that defines the configuration, or inputting entries (such as in an application presented by the portal) to define the configuration. The service provider may select an operation for defining the configuration. The portal may determine a service provider selection of the operation for defining the configuration and proceed according. For example, the portal may determine whether the service provider selected to clone a previously generated profile in 304. If the portal determines that the service provider did not select to clone a previously generated profile in 304, the portal may determine whether the service provider selected to upload a data file in 306. If the portal determines that the service provider did not select upload a data file in 306, the portal may determine that the service provider selected to input entries to define the configuration for the profile. While an order for these determinations is described in the current embodiment, it should be understood that the order of the determinations and/or a default determination may be different in other embodiments.

If the portal determines that the service provider selected to clone a previously generated profile in 304, the portal may identify the previously generated profile based on information provided by the service provider (such as a profile ID, and/or a service provider selection from available previously generated profiles) in 308. Further, the portal may retrieve data related to the previously generated profile (such as the previously generated profile, a data file corresponding to the previously generated profile, and/or a binary file corresponding to the previously generated profile) from a database (such as the TEST database 110 (FIG. 1) and/or the PROD database 116 (FIG. 1)) in 308. The portal may generate a copy of the retrieved data. The portal may present an interface to the service provider that displays entries of a configuration corresponding to the copy of the retrieved data, where the service provider may edit the entries. Once the service provider indicates that editing of the entries has been completed, the portal may generate a data file based on the entries, where the data file can be used for generating the new profile. The data file may be a YAML file in some embodiments.

If the portal determines that the service provider selected to upload a file in 306, the portal may present an interface that allows the service provider to upload a file in 310. The service provider may upload a profile data file in 310. The portal may utilize the profile data file as a data file for generating the profile or may generate a data file based on the profile data file to be utilized for generating the profile. The data file may be a YAML file in some embodiments. In instances where the profile data file uploaded by the service provider is in a different format than the format to be utilized for generating the profile, the portal may convert the profile data file into the format to be utilized for generating the profile.

If the portal determines that the service provider has selected to input entries, the portal may present an interface to the service provider that allows the service provider to input root level settings in 312. The service provider may input entries into the interface to define a configuration for the profile to be generated. In some embodiments, the entries may include a country code and/or a hardware security module (HSM) key ID. The portal may also allow the service provider to select a kernel and/or a payment network operator (PNO) to which the profile can be assigned in 314. In 316, the portal may determine whether the service provider indicates that more kernels and/or PNOs are to be allowed to have the profile assigned. If the portal determines that the service provider indicates that more kernels and/or more PNOs are to be allowed in 316, the portal may return to 314. If the portal determines that the service provider indicates that the indicated kernels and/or PNOs are complete in 316, the portal may generate a data file based on the entries for the root level settings, and/or the indicated kernels and/or PNOs.

In 318, the procedure 300 may proceed with the data file generated and/or received by the portal. The procedure 300 may proceed from 318 to 320. 320 of FIG. 3 may proceed to 320 of FIG. 4.

The procedure 300 may proceed from 320 to 402. In 402, a data file editor may be presented to edit profile fields within the data file. In some embodiments, the data file editor may be a YAML editor. The data file editor may allow a user to change fields within the data file.

In 404, the system may determine whether the data file is to be submitted for review. For example, a user may indicate whether the data file resulting from the data file editor in 402 is to be submitted for review. The system may determine where a user has indicated that the data file is to be submitted for review. If the system determines that the data is not to be submitted for review, the system may determine whether the data file is to be discarded in 406, such as by querying a user whether the data file should be discarded. If the system determines that the data file is to be discarded, the procedure 300 may proceed from 406 to 306 via 408, where the system may determine whether the service provider selected the option of uploading a profile data file to generate the profile. If the system determines that the profile is not to be discarded, the procedure 300 may proceed from 406 to 402, where the data file is presented in data file editor for editing.

If the system determines that the data file is to be submitted for review in 404, the procedure may proceed to 410. In 410, the status of the profile may be changed to in review. For example, the data file may be changed to the status of in review. The data file being changed to the status of being in review may indicate that the data is to be reviewed.

In 412, a task may be created for review of the data file. For example, a task may be created that the system is to review the data file and/or a user is to review the data file. In the instance where a user is to review the data file, the task being created may cause a notification to be provided to the user.

The procedure 300 may proceed from 412 to 414. 414 of FIG. 4 may proceed to 414 of FIG. 5.

The procedure 300 may proceed from 414 to 502. In 502, the system may determine a review type for the review. For example, a user may indicate a type of review for the data file. The system may present the options of reviewing the data file by downloading the data file for review and/or reviewing the data file in an editor.

If the system determines that the data file is to be reviewed in the editor, the procedure 300 may proceed to 504, where the system may display the data file in an editor for review. For example, the system may display the data file in a data file editor. In some embodiments, the data file editor may be a YAML editor. The data file editor may allow a user to review the data file and add comments to the data file.

If the system determines that the data file is to be downloaded, the procedure 300 may proceed to 506, where the system may allow the data file to be downloaded. For example, a user may download the data file from the system for external review. The procedure 300 may proceed to 506 to 504, where comments may be added to the data file based on the external review.

If 508, the system may determine whether the data file has been approved. For example, the user may indicate whether the data file reviewed in 504 has been approved. If the system determines that the data is not approved, the procedure 300 may proceed to 510, where the profile is sent back to the editor. In particular, the data file may be sent back for presentation in the editor in 402 via 512.

If the system determines that the data file is approved in 508, the procedure 300 may proceed to 514, where the profile may be approved. For example, the system may determine that the data profile is approved to be utilized for generating a profile. In 516, a status of the profile may be changed to approved. For example, a status of the data file may be changed to approved. The data file may be provided for generating a profile, such as generating a binary file from the data file and signing the binary file, such as described in relation to the service provider interface device 104, the profile managers (such as the TEST profile manager 106 (FIG. 1) and/or the PROD profile manager 114 (FIG. 1)), and the PKI 108. The system may generate the profile from the data file.

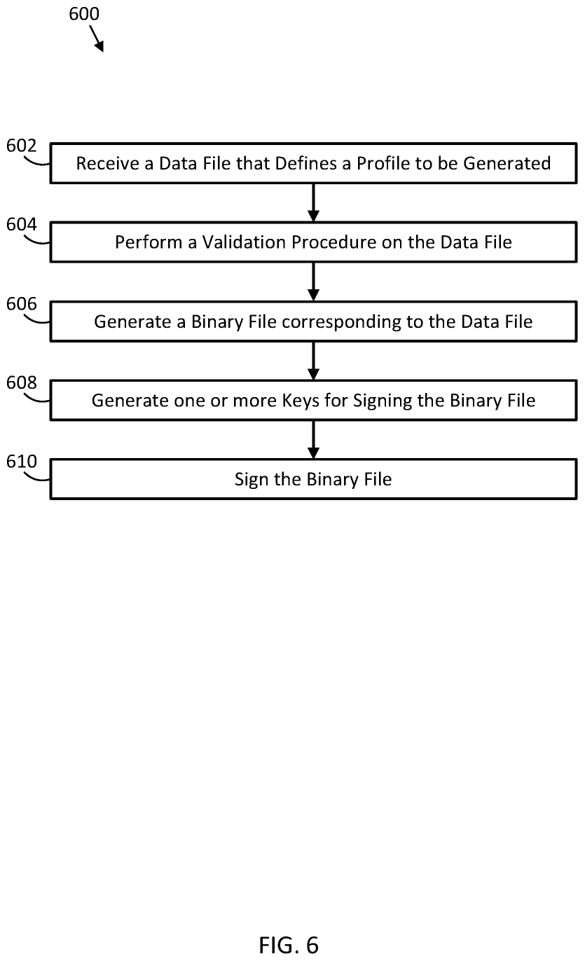

FIG. 6 illustrates an example procedure 600 for generating a profile in accordance with some embodiments. For example, the procedure 600 may be performed to generate a profile for a kernel to be utilized for data transfers. The procedure 600 may be performed by a system, such as the system described in relation to the system arrangement 100 (FIG. 1).

In 602, the procedure 600 may include receiving a data file that defines a profile to be generated. For example, the system may receive a data file that defines a profile to be generated for a kernel to be utilized for data transfer. The reception of the data file may include receiving a profile data file, receiving a data file associated with a previously generated profile requested to be cloned, and/or receiving a data file based on entries provided by service provider, as described throughout this disclosure.

In 604, the procedure 600 may include performing a validation procedure on the data file. For example, the system may perform a validation procedure on the data file to determine validation of the profile for generation.

In some embodiments, performing the validation procedure may include performing a first set of validations on the data file. The system may generate an intermediate file based at least in part on the data file, the intermediate file being a different format from the data file. The system may perform a second set of validations on the intermediate file as part of the performing the validation procedure.

In some embodiments, performing the validation procedure may include validating formats of one or more entries within the data file. Further, performing the validation procedure may include validating one or more values within the data file. The system may further validate any interdependencies between the one or more values within the data file.

In 606, the procedure 600 may include generating a binary file corresponding to the data file. For example, the system may generate a binary file corresponding to the data file, the binary file to be utilized for the profile. In some embodiments, the binary file may include a TEST binary file.

In 608, the procedure 600 may include generating one or more keys for signing the binary file. For example, the system may generate one or more keys for signing the binary file based at least in part on the profile being validated for generation. In some embodiments, the one or more keys may be generated by a profile manager (such as the TEST profile manager 106 (FIG. 1) and/or the PROD profile manager 114 (FIG. 1)) of the system. Further, the one or more keys may include a first set of one or more keys.

In 610, the procedure 600 may include signing the binary file. For example, the system may sign the binary file with the one or more keys to produce the profile. In some embodiments, the profile may include a TEST version profile (such as a profile generated by the TEST profile manager 106).

In some embodiments, signing the binary file may include generating a certificate chain corresponding to the data file. Further, signing the binary file may include signing the binary file with the certificate chain in some embodiments.

In some embodiments, signing the binary file may include generating, by a profile manager of the system, a CSR with a public key of the one or more keys. Further, the system may provide, by the profile manager to a PKI of the system, the CSR. The system may generate, by the PKI, a certificate chain based at least in part on the CSR. Further, the system may sign, by the profile manager, the binary file with the certificate chain.

In some of the embodiments where the binary file includes a TEST binary file and the profile includes a TEST version file, the procedure 600 may further include storing the TEST version profile in a TEST database of the system, the TEST database of the system to provide limited access to the TEST version profile. For example, the system may store the TEST version profile in a TEST database.

In some embodiments, the procedure 600 may further include receiving an indication to promote the TEST version profile to a PROD version profile (such as a profile generated by the PROD profile manager 114). For example, the system may receive an indication to promote the TEST version profile to a PROD version profile. The indication may include a profile ID that indicates the TEST version profile.

In some embodiments, procedure 600 may further include generating the PROD version profile based at least in part on the indication to promote the TEST version profile. For example, the system may generate the PROD version profile.

In some embodiments, to generate the PROD version profile may include generating a PROD binary file corresponding to the data file, the PROD binary file to be utilized for the PROD version profile. Generating the PROD version profile may further include generating a second set of one or more keys for signing the PROD binary file. Further, the system may sign the PROD binary file with the second set of one or more keys to produce the PROD version profile.

In some embodiments, the TEST binary file may be generated by a TEST profile manager of the system (such as the TEST profile manager 106). Further, the first set of one or more keys may be generated by the TEST profile manager in some embodiments. In some embodiments, the PROD binary file may be generated by a PROD profile manager of the system (such as the PROD profile manager 114). Further, the second set of one or more keys may be generated by the PROD profile manager in some embodiments.

In some embodiments, signing the TEST binary file may include generating, by the TEST profile manager, a first CSR with a first public key of the first set of one or more keys. The system may further provide, by the TEST profile manager to a PKI of the system (such as the PKI 108 (FIG. 1)), the first CSR as part of the signing of the TEST binary file. Signing the TEST binary file may further include generating, by the PKI a first certificate chain based at least in part on the first CSR. Signing the TEST binary file may include signing, by the TEST profile manager, the TEST binary file with the first certificate chain to produce the TEST version profile.

In some embodiments, signing the PROD binary file may include generating, by the PROD profile manager, a second CSR with a second public key of the second set of one or more keys. The system may further provide, by the PROD profile manager to the PKI, the second CSR as part of the signing of the PROD binary file. Signing the PROD binary file may further include generating, by the PKI, a second certificate chain based at least in part on the second CSR, the second certificate chain being different than the first certificate chain. Signing the PROD binary file may include signing, by the PROD profile manager, the PROD binary file with the second certificate chain to produce the PROD version profile.

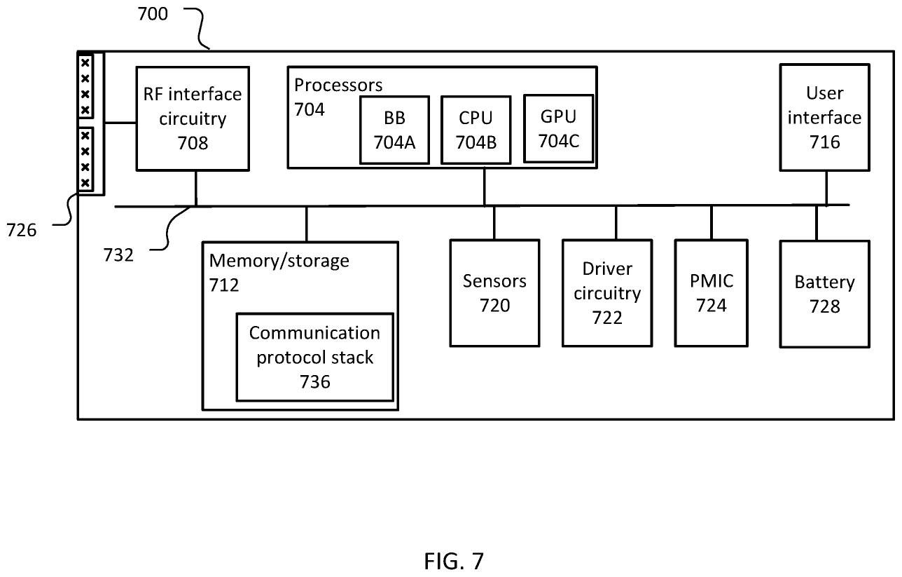

FIG. 7 illustrates an example user equipment (UE) 700 in accordance with some embodiments. The UE 700 may be an example of one of the terminals (such as the first terminal 112 (FIG. 1) and/or the second terminal 118 (FIG. 1)) that may utilize profiles generated by the system. The UE 700 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 700 may be a RedCap UE or NR-Light UE.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple input, multiple output communications. The antenna 726 may include microstrip antennas, printed antennas fabricated on the surface of one or more printed circuit boards, patch antennas, phased array antennas, etc. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 700 may power down for brief intervals of time and thus save power. If there is no data traffic activity for an extended period of time, then the UE 700 may transition off to an RRC_Idle state, where it disconnects from the network and does not perform operations such as channel quality feedback, handover, etc. The UE 700 goes into a very low power state, and it performs paging where again it periodically wakes up to listen to the network and then powers down again. The UE 700 may not receive data in this state; in order to receive data, it may be required to transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

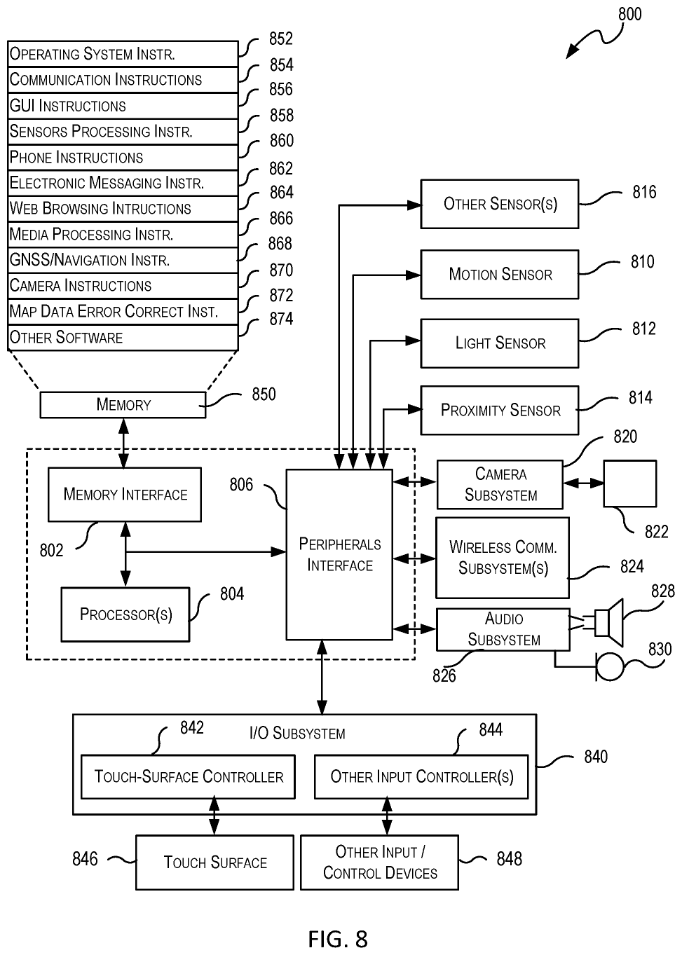

FIG. 8 is a block diagram of an example computing device 800 that can implement the features and processes of FIGS. 1-6 in accordance with some embodiments. The computing device 800 is an example of the partner device 102 (FIG. 1), the service provider interface device 104 (FIG. 1), the TEST profile manager 106 (FIG. 1), the PKI 108 (FIG. 1), the first terminal 112 (FIG. 1), the PROD profile manager 114 (FIG. 1), and/or the second terminal 118 (FIG. 1). The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822 (e.g., a charged coupled device (CCD) or a complementary metal-oxide semiconductor (CMOS) optical sensor) can be utilized to facilitate camera functions, such as recording photographs and video clips. The camera subsystem 820 and the optical sensor 822 can be used to collect images of a user to be used during authentication of a user (e.g., by performing facial recognition analysis).

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voice printing and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including, but not limited to, capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumbwheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some examples, the computing device 800 can present recorded audio and/or video files, such as MP3, AAC, and MPEG files. In some examples, the computing device 800 can include the functionality of an MP3 player, such as an iPod™.

The memory interface 802 can be coupled to memory 850. The memory 850 can include high-speed random-access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some examples, the operating system 852 can be a kernel (e.g., UNIX kernel). In some examples, the operating system 852 can include instructions for generating a profile. For example, operating system 852 can implement the profile generation operations as described in relation to FIGS. 1-6.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store software instructions 872 to facilitate other processes and functions, such as the profile storage processes and functions as described with reference to FIGS. 1-6.

The memory 850 can also store other software instructions 874, such as web video instructions to facilitate web video-related processes and functions; and/or web shopping instructions to facilitate web shopping-related processes and functions. In some examples, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

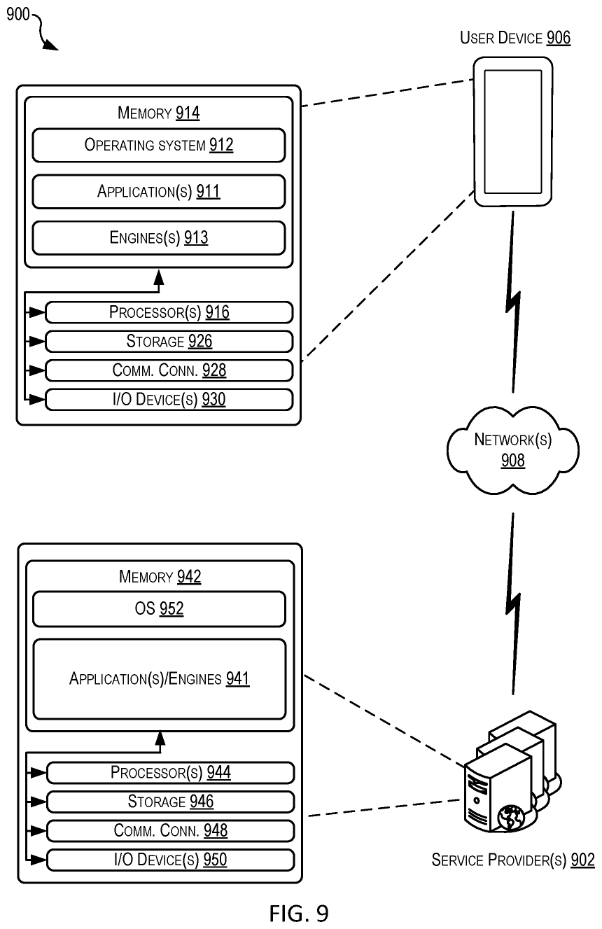

FIG. 9 illustrates an example architecture or environment 900 configured to implement techniques described herein in accordance with some embodiments. The architecture 900 includes a user device 906 (e.g., the first terminal 112 (FIG. 1) and/or the second terminal 118 (FIG. 1)) and a service provider computer 902 (e.g., the service provider interface device 104 (FIG. 1), the TEST profile manager 106 (FIG. 1), the PKI 108 (FIG. 1), the TEST database 110 (FIG. 1), the PROD profile manager 114 (FIG. 1), the PROD database 116 (FIG. 1), or some combination thereof). In some examples, the example architecture 900 may further be configured to enable the user device 906 and the service provider computer 902 to share information. In some examples, the devices may be connected via one or more networks 908 (e.g., via Bluetooth, WiFi, the Internet). In some examples, the service provider computer 902 may be configured to implement at least some of the techniques described herein with reference to the user device 906 and vice versa.

In some examples, the networks 908 may include any one or a combination of many different types of networks, such as cable networks, the Internet, wireless networks, cellular networks, satellite networks, other private and/or public networks, or any combination thereof. While the illustrated example represents the user device 906 accessing the service provider computer 902 via the networks 908, the described techniques may equally apply in instances where the user device 906 interacts with the service provider computer 902 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 906 may be any type of computing device such as, but not limited to, a mobile phone, a smartphone, a personal digital assistant (PDA), a laptop computer, a desktop computer, a thin-client device, a tablet computer, a wearable device such as a smart watch, an electronic device in a moveable vehicle or transport device, or the like. In some examples, the user device 906 may be in communication with the service provider computer 902 via the network 908, or via other network connections.

In one illustrative configuration, the user device 906 may include at least one memory 914 and one or more processing units (or processor(s)) 916. The processor(s) 916 may be implemented as appropriate in hardware, computer-executable instructions, firmware, or combinations thereof. Computer-executable instructions or firmware implementations of the processor(s) 916 may include computer-executable or machine-executable instructions written in any suitable programming language to perform the various functions described. The user device 906 may also include geo-location devices (e.g., a global positioning system (GPS) device or the like) for providing and/or recording geographic location information associated with the user device 906. In some examples, the processors 916 may include a GPU and a CPU.

The memory 914 may store program instructions that are loadable and executable on the processor(s) 916, as well as data generated during the execution of these programs. Depending on the configuration and type of the user device 906, the memory 914 may be volatile (such as random access memory (RAM)) and/or non-volatile (such as read-only memory (ROM), flash memory). The user device 906 may also include additional removable storage and/or non-removable storage 926 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 914 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 914 and the additional storage 926, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 914 and the additional storage 926 are both examples of non-transitory computer-storage media. Additional types of computer-storage media that may be present in the user device 906 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 906. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 906 may also contain communications connection(s) 928 that allow the user device 906 to communicate with a data store, another computing device or server, user terminals, and/or other devices via the network 908. The user device 906 may also include I/O device(s) 930, such as a keyboard, a mouse, a pen, a voice input device, a touch screen input device, a display, speakers, and a printer.

Turning to the contents of the memory 914 in more detail, the memory 914 may include an operating system 912 and/or one or more application programs or services for implementing the features disclosed herein such as applications 911 (e.g., map applications, web application) and map engine 913. The techniques described with respect to FIGS. 1-32 may be performed by the map engine 913.

The service provider computer 902 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 902 may be in communication with the user device 906 via the network 908, or via other network connections.

In one illustrative configuration, the service provider computer 902 may include at least one memory 942 and one or more processing units (or processor(s)) 944. The processor(s) 944 may be implemented as appropriate in hardware, computer-executable instructions, firmware, or combinations thereof. Computer-executable instructions or firmware implementations of the processor(s) 944 may include computer-executable or machine-executable instructions written in any suitable programming language to perform the various functions described.

The memory 942 may store program instructions that are loadable and executable on the processor(s) 944, as well as data generated during the execution of these programs. Depending on the configuration and type of service provider computer 902, the memory 942 may be volatile (such as RAM) and/or non-volatile (such as ROM and flash memory). The service provider computer 902 may also include additional removable storage and/or non-removable storage 946 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 942 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 942 and the additional storage 946, both removable and non-removable, are both additional examples of non-transitory computer-readable storage media.

The service provider computer 902 may also contain communications connection(s) 948 that allow the service provider computer 902 to communicate with a data store, another computing device or server, user terminals, and/or other devices via the network 908. The service provider computer 902 may also include I/O device(s) 950, such as a keyboard, a mouse, a pen, a voice input device, a touch input device, a display, speakers, and a printer.

Turning to the contents of the memory 942 in more detail, the memory 942 may include an operating system 952 and/or one or more application programs 941 or services for implementing the features disclosed herein such as those described with reference to FIGS. 1-6.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

As described above, one aspect of the present technology is the gathering, sharing, and use of data, including an authentication tag and data from which the tag is derived. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which device ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, users may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

In some examples, “circuitry” can refer to, be part of, or include hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The specific details of particular embodiments may be combined in any suitable manner or varied from those shown and described herein without departing from the spirit and scope of embodiments of the described techniques.

The above description of example embodiments of the described techniques has been presented for the purposes of illustration and description. It is not intended to be exhaustive or to limit the described techniques to the precise form described, and many modifications and variations are possible in light of the teaching above. The embodiments were chosen and described in order to best explain the principles of the described techniques and its practical applications to thereby enable others skilled in the art to best utilize the described techniques in various embodiments and with various modifications as are suited to the particular use contemplated.

All publications, patents, and patent applications cited herein are hereby incorporated by reference in their entirety for all purposes.

### Examples

In the following sections, further example embodiments are provided.

Example 1 may include one or more non-transitory computer-readable media having instructions that, when executed by one or more processors of a system, cause the system to receive a data file that defines a profile to be generated for a kernel to be utilized for data transfer, perform a validation procedure on the data file to determine validation of the profile for generation, generate a binary file corresponding to the data file, the binary file to be utilized for the profile, generate one or more keys for signing the binary file based at least in part on the profile being validated for generation, and sign the binary file with the one or more keys to produce the profile.

Example 2 may include the one or more non-transitory computer-readable media of claim 1, wherein to perform the validation procedure comprises to perform a first set of validations on the data file, generate an intermediate file based at least in part on the data file, the intermediate file being a different format from the data file, and perform a second set of validations on the intermediate file.

Example 3 may include the one or more non-transitory computer-readable media of claim 1, wherein to perform the validation procedure comprises to validate formats of one or more entries within the data file, validate one or more values within the data file, and validate interdependencies between the one or more values within the data file.

Example 4 may include the one or more non-transitory computer-readable media of claim 1, wherein to sign the binary file comprises to generate a certificate chain corresponding to the data file, and sign the binary file with the certificate chain.

Example 5 may include the one or more non-transitory computer-readable media of claim 1, wherein the one or more keys are generated by a profile manager of the system, and wherein to sign the binary file comprises to generate, by the profile manager, a certificate signing request (CSR) with a public key of the one or more keys, provide, by the profile manager to a public key infrastructure (PKI) of the system, the CSR, generate, by the PKI, a certificate chain based at least in part on the CSR, and sign, by the profile manager, the binary file with the certificate chain.

Example 6 may include the one or more non-transitory computer-readable media of claim 1, wherein the binary file comprises a TEST binary file, wherein the profile comprises a TEST version profile, and wherein the instructions, when executed by the one or more processors of the system, further cause the system to store the TEST version profile in a TEST database of the system, the TEST database of the system to provide limited access to the TEST version profile, receive an indication to promote the TEST version profile to a production (PROD) version profile, generate the PROD version profile based at least in part on the indication to promote the TEST version profile, and store the PROD version profile in a PROD database of the system, the PROD database of the system to provide expanded access to the PROD version profile.

Example 7 may include the one or more non-transitory computer-readable media of claim 6, wherein the one or more keys comprises a first set of one or more keys, and wherein to generate the PROD version profile comprises to generate a PROD binary file corresponding to the data file, the PROD binary file to be utilized for the PROD version profile, generate a second set of one or more keys for signing the PROD binary file, and sign the PROD binary file with the second set of one or more keys to produce the PROD version profile.

Example 8 may include the one or more non-transitory computer-readable media of claim 7, wherein the TEST binary file is generated by a TEST profile manager of the system, wherein the first set of one or more keys is generated by the TEST profile manager, wherein the PROD binary file is generated by a PROD profile manager of the system, and wherein the second set of one or more keys is generated by the PROD profile manager.

Example 9 may include the one or more non-transitory computer-readable media of claim 8, wherein to sign the TEST binary file comprises to generate, by the TEST profile manager, a first certificate signing request (CSR) with a first public key of the first set of one or more keys, provide, by the TEST profile manager to a public key infrastructure (PKI) of the system, the first CSR, generate, by the PKI, a first certificate chain based at least in a part on the first CSR, and sign, by the TEST profile manager, the TEST binary file with the first certificate chain to produce the TEST version profile, and to sign the PROD binary file comprises to generate, by the PROD profile manager, a second CSR with a second public key of the second set of one or more keys, provide, by the PROD profile manager to the PKI, the second CSR, generate, by the PKI, a second certificate chain based at least in part on the second CSR, the second certificate chain being different than the first certificate chain, and sign, by the PROD profile manager, the PROD binary file with the second certificate chain to produce the PROD version profile.

Example 10 may include a method of generating a profile, comprising receiving, by a system, a data file that defines the profile to be generated for a kernel to be utilized for data transfer, performing, by the system, a validation procedure on the data file to determine validation of the profile for generation, generating, by the system, a binary file corresponding to the data file, the binary file to be utilized for the profile, generating, by the system, one or more keys for signing the binary file based at least in part on the profile being validated for generation, and signing, by the system, the binary file with the one or more keys to produce the profile.

Example 11 may include the method of claim 10, wherein performing the validation procedure comprises performing a first set of validations on the data file, generating an intermediate file based at least in part on the data file, the intermediate file being a different format from the data file, and performing a second set of validations on the intermediate file.

Example 12 may include the method of claim 10, wherein performing the validation procedure comprises validating formats of one or more entries within the data file, validating one or more values within the data file, and validating interdependencies between the one or more values within the data file.

Example 13 may include the method of claim 10, wherein signing the binary file comprises generating a certificate chain corresponding to the data file, and signing the binary file with the certificate chain.

Example 14 may include the method of claim 10, wherein the one or more keys are generated by a profile manager of the system, and wherein signing the binary file comprises generating, by the profile manager, a certificate signing request (CSR) with a public key of the one or more keys, providing, by the profile manager to a public key infrastructure (PKI) of the system, the CSR, generating, by the PKI, a certificate chain based at least in part on the CSR, and signing, by the profile manager, the binary file with the certificate chain.

Example 15 may include the method of claim 10, wherein the binary file comprises a TEST binary file, wherein the profile comprises a TEST version profile, and wherein the method further comprises storing, by the system, the TEST version profile in a TEST database of the system, the TEST database of the system to provide limited access to the TEST version profile, receiving, by the system, an indication to promote the TEST version profile to a production (PROD) version profile, generating, by the system, the PROD version profile based at least in part on the indication to promote the TEST version profile, and storing, by the system, the PROD version profile in a PROD database of the system, the PROD database of the system to provide expanded access to the PROD version profile.

Example 16 may include the method of claim 15, wherein the one or more keys comprises a first set of one or more keys, and wherein generating the PROD version profile comprises to generating a PROD binary file corresponding to the data file, the PROD binary file to be utilized for the PROD version profile, generating a second set of one or more keys for signing the PROD binary file, and signing the PROD binary file with the second set of one or more keys to produce the PROD version profile.

Example 17 may include a system, comprising memory to store a profile, and one or more processors coupled to the memory, the one or more processors to receive a data file that defines the profile to be generated for a kernel to be utilized for data transfer, perform a validation procedure on the data file to determine validation of the profile for generation, generate a binary file corresponding to the data file, the binary file to be utilized for the profile, generate one or more keys for signing the binary file based at least in part on the profile being validated for generation, and sign the binary file with the one or more keys to produce the profile.

Example 18 may include the system of claim 17, wherein to sign the binary file comprises to generate a certificate chain corresponding to the data file, and sign the binary file with the certificate chain.

Example 19 may include the system of claim 17, wherein the one or more keys are generated by a profile manager of the system, and wherein to sign the binary file comprises to generate, by the profile manager, a certificate signing request (CSR) with a public key of the one or more keys, provide, by the profile manager to a public key infrastructure (PKI) of the system, the CSR, generate, by the PKI, a certificate chain based at least in part on the CSR, and sign, by the profile manager, the binary file with the certificate chain.

Example 20 may include the system of claim 17, wherein the binary file comprises a TEST binary file, wherein the profile comprises a TEST version profile, and wherein the one or more processors are further to store the TEST version profile in a TEST database of the system, the TEST database of the system to provide limited access to the TEST version profile, receive an indication to promote the TEST version profile to a production (PROD) version profile, generate the PROD version profile based at least in part on the indication to promote the TEST version profile, and store the PROD version profile in a PROD database of the system, the PROD database of the system to provide expanded access to the PROD version profile.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors of a system, cause the system to:
receive a data file that defines a profile to be generated for a kernel to be utilized for data transfer;
perform a validation procedure on the data file to determine validation of the profile for generation;
generate a binary file corresponding to the data file, the binary file to be utilized for the profile;
generate one or more keys for signing the binary file based at least in part on the profile being validated for generation; and
sign the binary file with the one or more keys to produce the profile.

2. The one or more non-transitory computer-readable media of claim 1, wherein to perform the validation procedure comprises to:
perform a first set of validations on the data file;
generate an intermediate file based at least in part on the data file, the intermediate file being a different format from the data file; and
perform a second set of validations on the intermediate file.

3. The one or more non-transitory computer-readable media of claim 1, wherein to perform the validation procedure comprises to:
validate formats of one or more entries within the data file;
validate one or more values within the data file; and
validate interdependencies between the one or more values within the data file.

4. The one or more non-transitory computer-readable media of claim 1, wherein to sign the binary file comprises to:
generate a certificate chain corresponding to the data file; and
sign the binary file with the certificate chain.

5. The one or more non-transitory computer-readable media of claim 1, wherein the one or more keys are generated by a profile manager of the system, and wherein to sign the binary file comprises to:
generate, by the profile manager, a certificate signing request (CSR) with a public key of the one or more keys;
provide, by the profile manager to a public key infrastructure (PKI) of the system, the CSR;
generate, by the PKI, a certificate chain based at least in part on the CSR; and
sign, by the profile manager, the binary file with the certificate chain.

6. The one or more non-transitory computer-readable media of claim 1, wherein the binary file comprises a TEST binary file, wherein the profile comprises a TEST version profile, and wherein the instructions, when executed by the one or more processors of the system, further cause the system to:
store the TEST version profile in a TEST database of the system, the TEST database of the system to provide limited access to the TEST version profile;
receive an indication to promote the TEST version profile to a production (PROD) version profile;
generate the PROD version profile based at least in part on the indication to promote the TEST version profile; and
store the PROD version profile in a PROD database of the system, the PROD database of the system to provide expanded access to the PROD version profile.

7. The one or more non-transitory computer-readable media of claim 6, wherein the one or more keys comprises a first set of one or more keys, and wherein to generate the PROD version profile comprises to:
generate a PROD binary file corresponding to the data file, the PROD binary file to be utilized for the PROD version profile;
generate a second set of one or more keys for signing the PROD binary file; and
sign the PROD binary file with the second set of one or more keys to produce the PROD version profile.

8. The one or more non-transitory computer-readable media of claim 7, wherein the TEST binary file is generated by a TEST profile manager of the system, wherein the first set of one or more keys is generated by the TEST profile manager, wherein the PROD binary file is generated by a PROD profile manager of the system, and wherein the second set of one or more keys is generated by the PROD profile manager.

9. The one or more non-transitory computer-readable media of claim 8, wherein:
to sign the TEST binary file comprises to:
generate, by the TEST profile manager, a first certificate signing request (CSR) with a first public key of the first set of one or more keys;
provide, by the TEST profile manager to a public key infrastructure (PKI) of the system, the first CSR;
generate, by the PKI, a first certificate chain based at least in a part on the first CSR; and
sign, by the TEST profile manager, the TEST binary file with the first certificate chain to produce the TEST version profile; and
to sign the PROD binary file comprises to:
generate, by the PROD profile manager, a second CSR with a second public key of the second set of one or more keys;
provide, by the PROD profile manager to the PKI, the second CSR;
generate, by the PKI, a second certificate chain based at least in part on the second CSR, the second certificate chain being different than the first certificate chain; and
sign, by the PROD profile manager, the PROD binary file with the second certificate chain to produce the PROD version profile.

10. A method of generating a profile, comprising:
receiving, by a system, a data file that defines the profile to be generated for a kernel to be utilized for data transfer;
performing, by the system, a validation procedure on the data file to determine validation of the profile for generation;
generating, by the system, a binary file corresponding to the data file, the binary file to be utilized for the profile;
generating, by the system, one or more keys for signing the binary file based at least in part on the profile being validated for generation; and
signing, by the system, the binary file with the one or more keys to produce the profile.

11. The method of claim 10, wherein performing the validation procedure comprises:
performing a first set of validations on the data file;
generating an intermediate file based at least in part on the data file, the intermediate file being a different format from the data file; and
performing a second set of validations on the intermediate file.

12. The method of claim 10, wherein performing the validation procedure comprises:
validating formats of one or more entries within the data file;
validating one or more values within the data file; and
validating interdependencies between the one or more values within the data file.

13. The method of claim 10, wherein signing the binary file comprises:
generating a certificate chain corresponding to the data file; and
signing the binary file with the certificate chain.

14. The method of claim 10, wherein the one or more keys are generated by a profile manager of the system, and wherein signing the binary file comprises:
generating, by the profile manager, a certificate signing request (CSR) with a public key of the one or more keys;
providing, by the profile manager to a public key infrastructure (PKI) of the system, the CSR;
generating, by the PKI, a certificate chain based at least in part on the CSR; and
signing, by the profile manager, the binary file with the certificate chain.

15. The method of claim 10, wherein the binary file comprises a TEST binary file, wherein the profile comprises a TEST version profile, and wherein the method further comprises:
storing, by the system, the TEST version profile in a TEST database of the system, the TEST database of the system to provide limited access to the TEST version profile;
receiving, by the system, an indication to promote the TEST version profile to a production (PROD) version profile;
generating, by the system, the PROD version profile based at least in part on the indication to promote the TEST version profile; and
storing, by the system, the PROD version profile in a PROD database of the system, the PROD database of the system to provide expanded access to the PROD version profile.

16. The method of claim 15, wherein the one or more keys comprises a first set of one or more keys, and wherein generating the PROD version profile comprises to:
generating a PROD binary file corresponding to the data file, the PROD binary file to be utilized for the PROD version profile;
generating a second set of one or more keys for signing the PROD binary file; and
signing the PROD binary file with the second set of one or more keys to produce the PROD version profile.

17. A system, comprising:
memory to store a profile; and
one or more processors coupled to the memory, the one or more processors to:
receive a data file that defines the profile to be generated for a kernel to be utilized for data transfer;
perform a validation procedure on the data file to determine validation of the profile for generation;
generate a binary file corresponding to the data file, the binary file to be utilized for the profile;
generate one or more keys for signing the binary file based at least in part on the profile being validated for generation; and
sign the binary file with the one or more keys to produce the profile.

18. The system of claim 17, wherein to sign the binary file comprises to:
generate a certificate chain corresponding to the data file; and
sign the binary file with the certificate chain.

19. The system of claim 17, wherein the one or more keys are generated by a profile manager of the system, and wherein to sign the binary file comprises to:
generate, by the profile manager, a certificate signing request (CSR) with a public key of the one or more keys;
provide, by the profile manager to a public key infrastructure (PKI) of the system, the CSR;
generate, by the PKI, a certificate chain based at least in part on the CSR; and
sign, by the profile manager, the binary file with the certificate chain.

20. The system of claim 17, wherein the binary file comprises a TEST binary file, wherein the profile comprises a TEST version profile, and wherein the one or more processors are further to:
store the TEST version profile in a TEST database of the system, the TEST database of the system to provide limited access to the TEST version profile;
receive an indication to promote the TEST version profile to a production (PROD) version profile;
generate the PROD version profile based at least in part on the indication to promote the TEST version profile; and
store the PROD version profile in a PROD database of the system, the PROD database of the system to provide expanded access to the PROD version profile.
